(19) United States
(12) Patent Application Publication
(10) Pub. No.: US 2013/0194988 A1
(43) Pub. Date: Aug. 1, 2013

(54) METHOD AND APPARATUS FOR ACTIVATION AND DEACTIVATION OF A TRANSMISSION MODE

(71) Applicants: Keiichi KUBOTA, Weybridge (GB); Brian Alexander MARTIN, Farnham (GB)

(72) Inventors: Keiichi KUBOTA, Weybridge (GB); Brian Alexander MARTIN, Farnham (GB)

(73) Assignee: RENESAS MOBILE CORPORATION, TOKYO (JP)

(21) Appl. No.: 13/371,531

(22) Filed: Feb. 13, 2012

(30) Foreign Application Priority Data
Jan. 30, 2012 (GB) 1201569.9

(51) Int. Cl. H04W 52/04; H04W 72/04

(52) U.S. Cl. 370/311; 370/329

(57) ABSTRACT

In a wireless communications network, a user equipment is capable of operating in a first mode in which uplink signals are transmitted using a single antenna and in at least a second mode in which uplink signals are transmitted using two or more antennas. It is determined at the user equipment whether to request activation of the first or second mode and a first message is sent to a network node requesting activation of the first or second mode together with Medium Access Control (MAC) Scheduling Information (SI). Alternatively, the user equipment sends, to the network node, an indication of a threshold for use in determining whether to activate the first or second mode together with user equipment capability information. A second message is received at the user equipment from the network node indicating whether the first or second mode should be activated.

### CROSS REFERENCE TO RELATED APPLICATION

This application claims benefit under 35 U.S.C. §119(a) and 37 CFR 1.55 to UK patent application no. 1201569.9, filed on Jan. 30, 2012, the entire content of which is hereby incorporated by reference.

### TECHNICAL FIELD

The present invention relates generally to a method and apparatus for activation and deactivation of a transmission mode of a user equipment in a wireless communication network, and more specifically, but not exclusively, to activation and deactivation of closed loop transmit diversity (CLTD) at a user equipment in a cellular wireless communications system.

### BACKGROUND

User Equipment for use in Wireless communications networks, such a Wideband Code Division Multiple Access (WCDMA) third generation (3G) wireless communications networks, may be provided with two or more antennas for transmission of uplink signals. The user equipment may be capable of operating in a mode in which signals are transmitted using a single antenna at the user equipment, and may also be capable of operating in a mode in which signals are transmitted using two or more antennas at the user equipment. For example, the mode in which signals are transmitted using two or more antennas at the user equipment may be a transmit diversity mode. The user equipment may use, for example, uplink Closed Loop Transmit Diversity (CLTD), in which feedback relating to characteristics of the spatial channel is used to assist the transmitter in choosing a transmission format. For example, Closed Loop Transmit Diversity (CLTD) may involve forming a beam using simultaneous transmission from the two or more antennas with appropriate amplitude and phase weighting, in a beamforming (BF) scheme.

The transmit diversity scheme may provide reduced loss in the uplink and this may allow a reduction in total transmission power in comparison with the transmission power that would be required for transmission from a single antenna. However, there may be an increase in power consumption associated with activation of Closed Loop Transmit Diversity (CLTD). For example, when beamforming is used, it may be required to power up two or more transmit power amplifiers and associated circuitry, and although the total transmitted power may be less than would have been the case for the use of a single antenna, this may or may not result in an overall reduction in power consumption at the user equipment. It has been found that activation of CLTD may typically give an overall reduction in current consumption at a user equipment for higher transmission powers, but may give an overall increase in power consumption for lower transmission powers. This effect has been described, for example, in 3GPP document R4-113521, relating to TSG-WG4 Meeting #59AH. It is known that the transition point, in terms of transmission power, from a net benefit to a net penalty in terms of current consumption is dependent on the specific implementation of the user equipment. The wireless communication network may therefore not have the necessary information to activate or deactivate a mode of operation involving use of two or more antennas at the user equipment, such as transmit diversity, in order to reduce power consumption and thereby increases battery life.

It is an object of the invention to address at least some of the limitations of the prior art systems.

### SUMMARY

In a first exemplary embodiment of the invention, there is provided a method of operating a user equipment in a wireless communications network, the user equipment being capable of operating in a first mode in which uplink signals are transmitted using a single antenna at the user equipment and in at least a second mode in which uplink signals are transmitted using two or more antennas at the user equipment, the method comprising:

determining, at the user equipment, whether to request activation of the first or second mode;

sending a first message to a first network node requesting activation of the first mode or the second mode in dependence on the determination, said first message being sent together with Medium Access Control (MAC) Scheduling Information (SI); and

activating the first or second mode in dependence on receipt of a second message at the user equipment from the network node indicating whether the first mode or the second mode should be activated.

In a second exemplary embodiment of the invention, there is provided an apparatus for use in a user equipment in a wireless communications network, the user equipment being capable of operating in a first mode in which uplink signals are transmitted using a single antenna at the user equipment and in at least a second mode in which uplink signals are transmitted using two or more antennas at the user equipment, the apparatus comprising at least one processor and at least one memory including computer program code, the at least one memory and the computer program code configured to, with the at least one processor, cause the apparatus to at least perform:

determining whether to request activation of the first or second mode;

sending a first message to a first network node requesting activation of the first mode or the second mode in dependence on the determination, said first message being sent together with Medium Access Control (MAC) Scheduling Information (SI); and

activating the first or second mode in dependence on receipt of a second message at the user equipment from the network node indicating whether the first mode or the second mode should be activated.

In a third exemplary embodiment of the invention, there is provided an apparatus for use in a user equipment in wireless communications network, the user equipment being capable of operating in a first mode in which uplink signals are transmitted using a single antenna at the user equipment and in at least a second mode in which uplink signals are transmitted using two or more antennas at the user equipment, the apparatus comprising at least one processor and at least one memory including computer program code, the at least one memory and the computer program code configured to, with the at least one processor, cause the apparatus to at least perform:

sending, to a network node, an indication of transmission power of the user equipment;

sending, to the network node, an indication of a threshold for use in determining whether to activate the first or second mode, said indication being sent together with user equipment capability information;

receiving an instruction to activate the first or second mode, the instruction being dependent on a determination at the network node of whether to activate the first or second mode based on a comparison of the indication of transmission power of the user equipment with the threshold; and

activating the first or second mode in dependence on receipt of said instruction.

Further features of the invention will be apparent form the following description of preferred embodiments of the invention, which are given by way of example only.

### BRIEF DESCRIPTION OF THE DRAWINGS

FIG. 1 is a schematic diagram showing a user equipment with two transmit antennas in a wireless network according to an embodiment of the invention;

FIG. 2 is a schematic representation of a graph showing current consumption improvement due to CLTD as a function of user equipment transmit power;

FIG. 3 is a diagram showing exchange of messages between a user equipment and the network, in which a determination whether to request activation of CLTD is made at the user equipment, according to an embodiment of the invention;

FIG. 4 is a diagram showing exchange of messages between a user equipment and the network, in which a determination whether to request activation of CLTD is made at the network, according to an embodiment of the invention;

FIG. 5 is a diagram showing exchange of messages between a user equipment and the network, in which a determination whether to request activation of CLTD is made at the network in dependence on a threshold sent by the user equipment in a RRC Connection Setup Complete message, according to an embodiment of the invention; and

FIG. 6 is a diagram showing exchange of messages between a user equipment and the network, in which a determination whether to request activation of CLTD is made at the network in dependence on a threshold sent by the user equipment in a UE Capability Information message, according to an embodiment of the invention.

### DETAILED DESCRIPTION

By way of example, embodiments of the invention will now be described in the context of Wideband Code Division Multiple Access (WCDMA) third generation (3G) wireless communications system. However, it will be understood that this is by way of example only and that other embodiments are not limited to use with a particular type of wireless system.

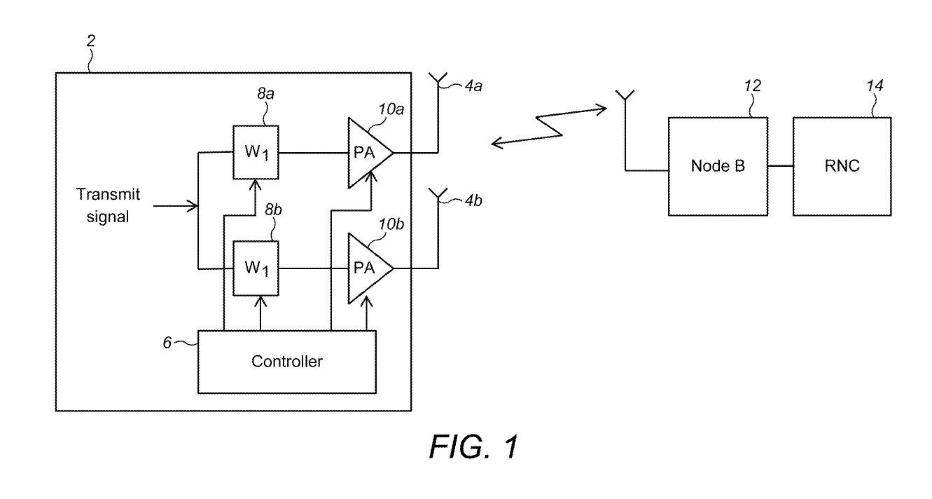

FIG. 1 shows a user equipment 2 with two transmit antennas 4a, 4b in a wireless network according to an embodiment of the invention, although in embodiments of the invention the user equipment may have more than two antennas. The user equipment is capable of operating in a first mode in which uplink signals are transmitted using a single antenna, and in at least a second mode in which uplink signals are transmitted using two or more antennas at the user equipment. Uplink signals are transmitted, in this example, to a Node B 12 of the wireless communications network, which is connected to a Radio Network Controller 14. The first mode may be a mode in which transmit diversity is deactivated and the second mode may be a mode in which transmit diversity is activated. The transmit diversity may be Closed Loop Transmit Diversity (CLTD), in which feedback relating to characteristics of the spatial channel is used to assist the transmitter in choosing a transmission format. For example, the transmit diversity may comprise forming a beam using the two or more antennas at the user equipment, or alternatively, the transmit diversity may comprise an antenna switching scheme. In a beamforming transmit diversity scheme, as shown in FIG. 1, an amplitude and phase weight 8a, 8b is applied to a transmit signal before amplification by respective power amplifiers 10a, 10b for transmission by the antennas 4a, 4b. The weights 8a, 8b and power amplifiers 10a, 10b may be controlled by a controller 6, comprising a processor and memory, to operate in the first or second mode.

In the scheme involve forming a beam, typically simultaneous transmission from the two or more antennas 4a, 4b is used with appropriate amplitude and phase weighting. In this case, two or more antenna power amplifiers are required to be powered, and furthermore the control and signalling for the beamforming scheme may involve an overhead of power consumption compared with the case where a transmit diversity mode is not selected. Although the link gain due to the gain of the antenna beam may allow a lower transmit power to be used than would be the case in a mode using a single transmit antenna, there is not necessarily an overall saving of power consumption due to the operation of the transmit diversity.

In the antenna switching scheme, for example, the antenna which experiences the best, for example lowest loss, link to the Node B is selected dynamically, as the characteristics of the link as seen by each antenna varies. For example, if the user equipment is moving, a first antenna may be in a position that would produce a fade at the Node B at a given time, but a second antenna, which is typically separated spatially from the first antenna, may be in a position that would not produce a fade at the Node B at that time, so that the second antenna would be selected. However, at another time, the reverse situation may apply, so that the first antenna may have moved away from the producing a fade at the Node B, but the second antenna, may have moved to a position that would produce a fade at the Node B, so that at this time the first antenna would be selected. Selection between antennas may be rapid, so that antenna power amplifiers may not be powered down between selections, and the control and signalling for the antenna switching scheme may involve an overhead of power consumption compared with the case where a transmit diversity mode is not selected. Although the link gain due to the selection of the best positioned antenna may allow a lower transmit power to be used than would be the case in a mode using a single transmit antenna, there is not necessarily an overall saving of power consumption due to the operation of the transmit diversity, although the trade off may be different from the case where the transmit diversity involves beamforming.

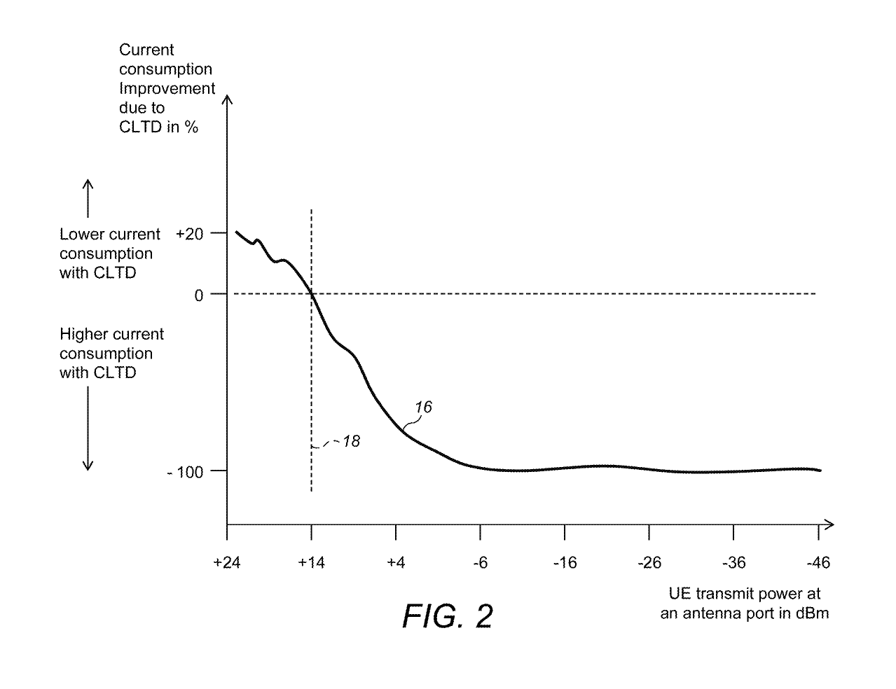

FIG. 2 is a schematic representation of a graph showing an example of current consumption improvement due to CLTD as a function of user equipment transmit power, for example with transmit diversity involving beamforming. It may be seen that in this example, the current consumption improvement 16 is approximately 20% at a high transmission power from an antenna port of the user equipment, in this example when the transmission power is approximately +24 dBm. By contrast, at low transmission powers, for example at a transmission power of −46 dBm, the current consumption improvement is approximately −100%, that is to say the current consumption has increased by 100%. It can also been seen from FIG. 2 that there is a threshold 18 of transmit power, in this example at approximately +14 dBm, above which current consumption is reduced by activation of CLTD.

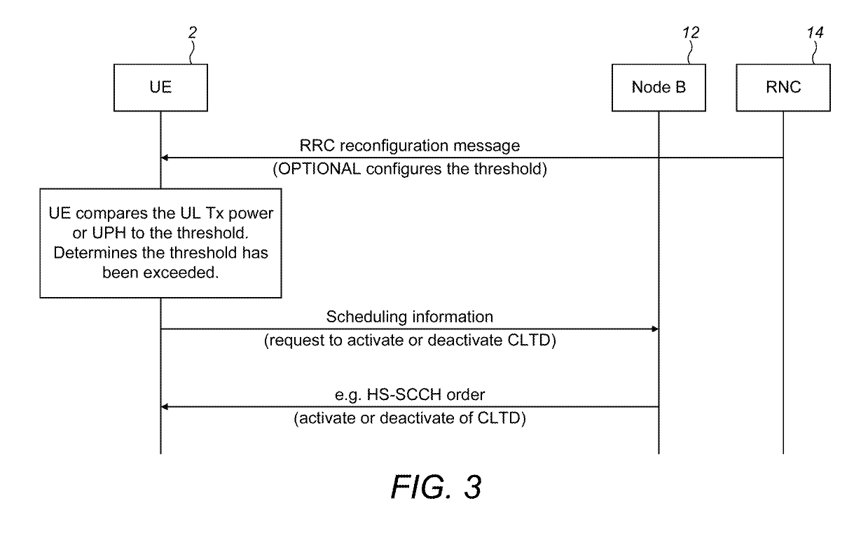

FIG. 3 is a diagram showing exchange of messages between a user equipment 2 and the network 12, 14, in which a determination whether to request activation of CLTD is made at the user equipment, according to an embodiment of the invention. As shown in FIG. 3, it is determined at the user equipment whether to request activation of the first or second mode, in this example the second mode involving the activation of CLTD and the first mode involving the deactivation of CLTD. The determination is based on an indication of transmission power of the user equipment, which may be an indication of transmission power of one antenna, or may be an indication of total transmission power from the user equipment. The indication may be a ratio of a transmission power to a maximum transmission power, for example an indicator of User Equipment Power Headroom (UPH). As shown in FIG. 3, the determination of whether to request activation of the first or second mode may be based on a comparison of the indication with a threshold. The threshold may be a pre-determined threshold held at the user equipment, or a message such as a RRC Reconfiguration Message may be received from a network node, typically from the Radio Network Controller (RNC) 14, configuring the threshold. An indication of the threshold may be received from the network node, which may be used together with information held at the user equipment to configure the threshold.

As shown in FIG. 3, a first message is sent form the user equipment to a first network node, typically a Node B 12, requesting activation of the first mode or the second mode, according to the determination at the user equipment. In an embodiment of the invention, the first message is sent together with Medium Access Control (MAC) Scheduling Information (SI), for example in a signalling field allocated for Medium Access Control (MAC) Scheduling Information (SI). For example, a single bit may indicate activation or deactivation of the second mode, that is to say, in this embodiment, activation or deactivation of CLTD.

It is not obvious to send the request for activation of the first mode or the second mode together with Medium Access Control (MAC) Scheduling Information (SI), since the signalling field for Scheduling Information is conventionally used for information relating to scheduling, such as for example how much data is to be sent, not for control, or a request for control, of a mode or function of the user equipment. Sending the request for activation of the first mode or the second mode together with Medium Access Control (MAC) Scheduling Information (SI) has an advantage that use may be made of an existing signalling field, the Scheduling Information field, that may be expected to be available in many configurations, and that may be expected to have sufficient spare capacity to accommodate the request, which may be a single bit, so that signalling overhead may not be increased.

Conventionally, a request for activation of a mode or function of the user equipment would be sent in a MAC header having spare capacity, for example a MAC-I or MAC-IS header. However, a suitable MAC header having spare capacity, such as a MAC-I or MAC-IS header, may only be currently used in a subset of states, such as in the CELL_FACH state for contention resolution, and so use of a MAC header such as this in further states may involve a signalling overhead. Furthermore, the spare bits in the MAC header may be better used for indicating features in the state for which the header is intended, such as the CELL_FACH state. Therefore, sending the request for activation of the first mode or the second mode together with Medium Access Control (MAC) Scheduling Information (SI) has an advantage that signalling overhead may be reduced in comparison with sending the request in a MAC header such as a MAC-I or MAC-IS header.

In an embodiment of the invention, the first message is sent via an uplink transport channel, such as an Enhanced Dedicated Channel (E-DCH). This has an advantage that the Scheduling Information of this channel may have spare capacity to carry the request for activation of the first or second mode, and that the channel is typically widely available.

As shown in FIG. 3, the first or second mode may be activated in dependence on receipt of a second message at the user equipment from the network node, typically the Node B, indicating whether the first mode or the second mode should be activated. The Node B may process the request from the user equipment, for example according to a policy regarding whether or not transmit diversity such as CLTD should be activated or deactivated.

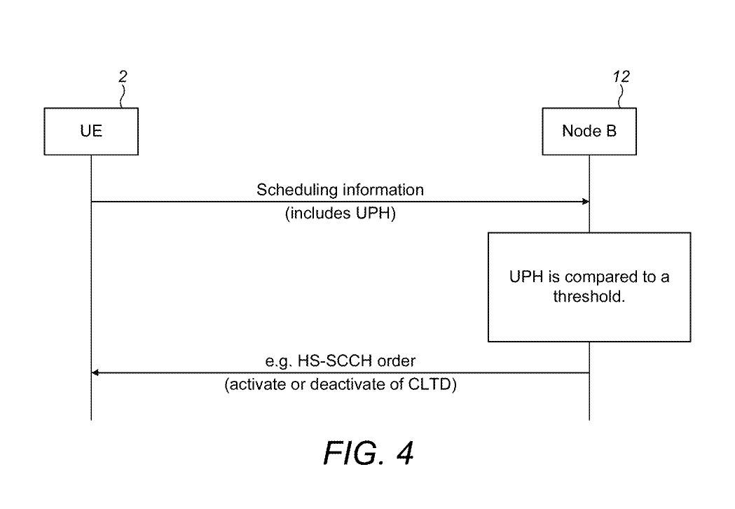

FIG. 4 illustrates an alternative embodiment in which a determination whether to request activation of CLTD is made at the network rather than at the user equipment. As may be seen in FIG. 4, an indication of transmission power of the user equipment is sent from the user equipment 2 to the network, typically to the Node B 12. The indication of transmission power of the user equipment may comprise a ratio of a transmission power to a maximum transmission power, such as the User Equipment Power Headroom (UPH) shown in FIG. 4. This information may be sent, as is conventional, in scheduling information. The indication of transmission power may indicate transmission power of one antenna, or may indicate total transmission power from the user equipment.

As shown in FIG. 4, the indication of transmission power, in this example the UPH, is compared with a threshold at the node B.

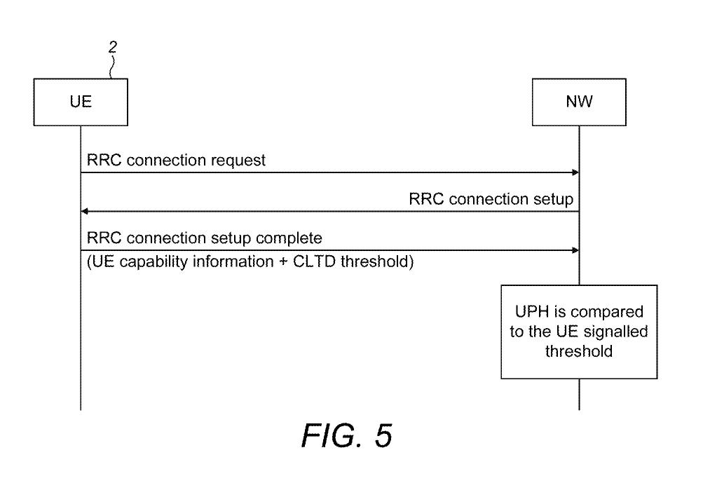

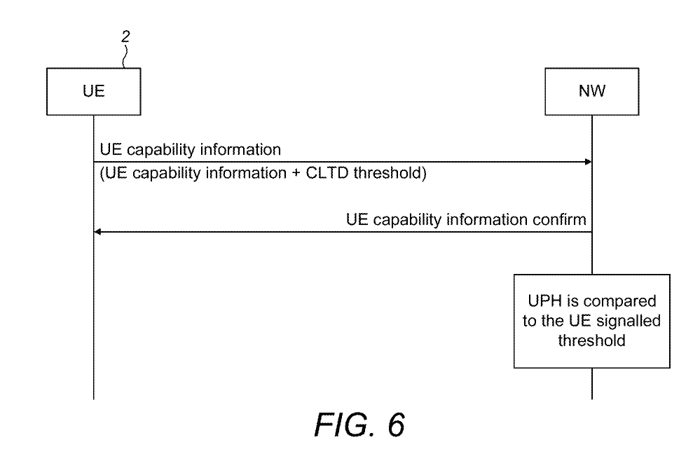

As shown in FIGS. 5 and 6, an indication of the threshold for use in determining whether to activate the first or second mode may be sent from the user equipment 2 to a network node, such as the Node B. The indication may be sent together with user equipment capability information. This has an advantage that the determination at the Node B may take into account the characteristics of the specific type of User Equipment (UE) that implements the transmit diversity, by using a threshold specific to a UE. This may give reduced current consumption at the UE compared with the case where a generic threshold were to be used at the network node. Sending the indication of the threshold (in the example of FIG. 5, the CLTD threshold) together with capability information has an advantage that existing messaging may be used, reducing signalling overhead. It is not obvious to send the indication of the threshold together with the capability information, since capability information conventionally indicates functionality of the user equipment rather than a physical value such as the indication of the threshold to be used in a determination whether to activate or deactivate a mode of operation of the physical layer, such as transmit diversity.

As shown in FIG. 5, the indication of the threshold may be sent in a RRC (Radio Resource Control) Connection Setup Complete message. This has an advantage of providing efficient signalling, by using a message that is sent when the UE establishes a RRC connection from idle mode.

Alternatively, as shown in FIG. 6, the indication of the threshold may be sent in a UE Capability Information message. This may be sent after SRNS (Serving Radio Network Subsystem) relocation or on inter-Radio Access Technology (inter-RAT) handover. This may be, for example, after a handover from E-UTRAN to UTRAN (Enhanced Universal Mobile Radio System Terrestrial Radio Access Network to Universal Mobile Radio System Terrestrial Radio Access Network), or from GERAN (GSM EDGE Radio Access Network) to UTRAN. This has an advantage of providing efficient signalling, by using a message that is sent on an inter-RAT handover.

As shown in FIG. 4, an instruction to activate the first or second mode is received at the user equipment, for example a HS-SCCH (High Speed Shared Control Channel) order, the instruction being dependent on a determination at the network node of whether to activate the first or second mode based on a comparison of the indication of transmission power of the user equipment with the threshold. The first or second mode may then be activated at the user equipment in dependence on receipt of the instruction.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

User Equipment (UE) includes mobile or cell phones (including so-called “smart phones”), personal digital assistants, pagers, tablet and laptop computers, content-consumption or generation devices (for music and/or video for example), data cards, USB dongles, etc.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of operating a user equipment in a wireless communications network, the user equipment being capable of operating in a first mode in which uplink signals are transmitted using a single antenna at the user equipment and in at least a second mode in which uplink signals are transmitted using two or more antennas at the user equipment, the method comprising:
determining, at the user equipment, whether to request activation of the first or second mode;
sending a first message to a first network node requesting activation of the first mode or the second mode in dependence on the determination, said first message being sent together with Medium Access Control (MAC) Scheduling Information (SI); and
activating the first or second mode in dependence on receipt of a second message at the user equipment from the network node indicating whether the first mode or the second mode should be activated.

2. A method according to any claim 1, wherein said sending of the first message comprises sending the first message in a signalling field allocated for Medium Access Control (MAC) Scheduling Information (SI) in an Enhanced Dedicated Channel (E-DCH).

3. A method according to claim 1, wherein said determining of whether to request activation of the first or second mode is based on an indication of transmission power of the user equipment.

4. A method according to claim 3, wherein said indication indicates User Equipment Power Headroom (UPH).

5. A method according to claim 3, wherein said determining of whether to request activation of the first or second mode is based on a comparison of said indication with a threshold.

6. A method according to claim 5, wherein an indication of said threshold is received from a Radio Network Controller (RNC).

7. A method according to claim 1, wherein the first mode is a mode in which transmit diversity is deactivated and the second mode is a mode in which transmit diversity is activated.

8. A method according to claim 7, wherein said transmit diversity is Closed Loop Transmit Diversity (CLTD).

9. Apparatus for use in a user equipment in a wireless communications network, the user equipment being capable of operating in a first mode in which uplink signals are transmitted using a single antenna at the user equipment and in at least a second mode in which uplink signals are transmitted using two or more antennas at the user equipment, the apparatus comprising at least one processor and at least one memory including computer program code, the at least one memory and the computer program code configured to, with the at least one processor, cause the apparatus to at least perform:
determining whether to request activation of the first or second mode;
sending a first message to a first network node requesting activation of the first mode or the second mode in dependence on the determination, said first message being sent together with Medium Access Control (MAC) Scheduling Information (SI); and
activating the first or second mode in dependence on receipt of a second message at the user equipment from the network node indicating whether the first mode or the second mode should be activated.

10. Apparatus according to claim 9, wherein said sending of the first message comprises sending the first message in a signalling field allocated for Medium Access Control (MAC) Scheduling Information (SI) in an Enhanced Dedicated Channel (E-DCH).

11. Apparatus according to claim 9, wherein said determining of whether to request activation of the first or second mode is based on an indication of transmission power of the user equipment.

12. Apparatus according to claim 11, wherein said indication indicates User Equipment Power Headroom (UPH).

13. Apparatus according to claim 11, wherein said determining of whether to request activation of the first or second mode is based on a comparison of said indication with a threshold.

14. Apparatus according to claim 13, wherein an indication of said threshold is received from a Radio Network Controller (RNC).

15. Apparatus according to claim 9, wherein the first mode is a mode in which Closed Loop Transmit Diversity (CLTD) is deactivated and the second mode is a mode in which Closed Loop Transmit Diversity (CLTD) is activated.

16. Apparatus for use in a user equipment in wireless communications network, the user equipment being capable of operating in a first mode in which uplink signals are transmitted using a single antenna at the user equipment and in at least a second mode in which uplink signals are transmitted using two or more antennas at the user equipment, the apparatus comprising at least one processor and at least one memory including computer program code, the at least one memory and the computer program code configured to, with the at least one processor, cause the apparatus to at least perform:
sending, to a network node, an indication of transmission power of the user equipment;
sending, to the network node, an indication of a threshold for use in determining whether to activate the first or second mode, said indication being sent together with user equipment capability information;
receiving an instruction to activate the first or second mode, the instruction being dependent on a determination at the network node of whether to activate the first or second mode based on a comparison of the indication of transmission power of the user equipment with the threshold; and
activating the first or second mode in dependence on receipt of said instruction.

17. Apparatus according to claim 16, wherein said sending of the indication of the threshold is via a RRC (Radio Resource Control) Connection Setup Complete message.

18. Apparatus according to claim 16, wherein said sending of the indication of the threshold is via a UE Capability Information message.

19. Apparatus according to claim 16, wherein said indication of transmission power indicates User Equipment Power Headroom (UPH).

20. Apparatus according to claim, 16 wherein the first mode is a mode in which Closed Loop Transmit Diversity (CLTD) is deactivated and the second mode is a mode in which Closed Loop Transmit Diversity (CLTD) is activated.
